(19) United States
(12) Patent Application Publication
(10) Pub. No.: US 2015/0042789 A1
(43) Pub. Date: Feb. 12, 2015

(54) DETERMINING THE DISTANCE OF AN OBJECT TO AN ELECTRONIC DEVICE

(71) Applicant: BlackBerry Limited, Waterloo (CA)

(72) Inventors: Andrew Michael INWOOD, Kitchener (CA); Tennessee CARMEL-VEILLEUX, Kitchener (CA)

(73) Assignee: BlackBerry Limited, Waterloo (CA)

(21) Appl. No.: 13/960,953

(22) Filed: Aug. 7, 2013

(51) Int. Cl. G01B 11/14

(52) U.S. Cl. CPC G01B 11/14
USPC 348/135

(57) ABSTRACT

Described is a method of determining a proximity of an object to an electronic device, the method comprising: determining the proximity of the object to the electronic device using a non-camera proximity sensor; and in response to the occurrence of the trigger event, determining the proximity of the object to the electronic device using a second proximity sensor.

### FIELD

The present matter is related to electronic devices and in particular to determining the proximity of an object to an electronic device.

### BACKGROUND

Communication devices, such as mobile communication devices or other electronic devices often include cameras and other sensors. The operation of such devices can be enhanced in various ways if the device is aware of the distance or proximity of one or more nearby object.

Using certain components of an electronic device to calculate or determine the proximity or distance of the electronic device to an object can drain the battery power of the electronic device at a relatively fast rate.

### BRIEF DESCRIPTION OF DRAWINGS

In order that the subject matter may be readily understood, embodiments are illustrated by way of examples in the accompanying drawings, in which:

FIG. 1 is a front elevation view of an example electronic device in accordance with example embodiments of the present disclosure;

FIG. 2 is a block diagram illustrating components of the example electronic device of FIG. 1 in accordance with example embodiments of the present disclosure;

FIG. 3 is a flow-chart depicting a method of determining a proximity of an object to an electronic device;

FIG. 4 is a flow-chart depicting another method of determining a proximity of an object to an electronic device;

FIG. 5 is a flow-chart depicting a method of calibrating a camera; and

FIG. 6 is a flow-chart depicting a method of using a calibrated camera to determine the proximity of an object.

### DETAILED DESCRIPTION

In accordance with an aspect, described is a method of determining a proximity of an object to an electronic device, the method comprising: determining the proximity of the object to the electronic device using a non-camera proximity sensor; and in response to the occurrence of the trigger event, determining the proximity of the object to the electronic device using a second proximity sensor.

In accordance with another aspect, described is an electronic device comprising: a non-camera proximity sensor for determining the proximity of an object to the electronic device; a second proximity sensor for determining the proximity of an object to the electronic device; a memory for storing instructions; and a processor for executing instructions stored on the memory, the processor coupled to the non-camera proximity sensor and the second proximity sensor, the processor configured to: determine the proximity of the object to the electronic device using the non-camera proximity sensor; and in response to an occurrence of a trigger event, determine the proximity of the object to the electronic device using the second proximity sensor.

In accordance with another aspect, described is a computer readable memory comprising computer-executable instructions which, when executed, cause a processor to: determine a proximity of an object to the electronic device using a non-camera proximity sensor; and determine the proximity of the object to the electronic device using a second proximity sensor.

In accordance with another aspect, described is a method of calibrating a camera to determine a distance of an object from the camera, the object associated with a feature, the method comprising: obtaining a distance of the object to the camera using a non-camera proximity sensor; capturing a calibration image, the calibration image comprising the object; obtaining a reference measurement of the feature associated with the object in the calibration image; and calculating a relationship between the distance of the object and the reference measurement of the feature.

Electronic devices, such as mobile communication devices, may be configured to determine whether an object is proximal to it, and the distance of the object. For example, an electronic device may be configured to determine the proximity of a nearby person. One or more proximity sensors may be used to determine the proximity of the object. The electronic device may include a camera that can also be used to detect proximity (i.e. acting as a proximity sensor) and a non-camera proximity sensor (i.e. a proximity sensor that is not a camera), for example. Cameras installed on electronic devices can be used to measure the proximity of an object by analyzing multiple captured images of the object, for example. However, capturing images using the camera and analyzing the captured images can drain the battery of the electronic device at a relatively fast rate (such as hundreds of milliamperes for example). On the other hand using certain non-camera proximity sensors can drain or deplete the battery at a relatively slow rate (such as tens of milliamperes or less). By way of further example, a non-camera proximity sensor may be able to run continuously for much longer than using the camera as a proximity sensor.

In one or more embodiments, the proximity of an object to an electronic device may be measured as a binary event. For example, the object may either be proximate to the electronic device or not. In other words a proximity sensor may be used to determine whether an object is within a pre-defined distance of the electronic device. If the object is measured (by the proximity sensor) to be within the predefined distance of the electronic device then that object is considered to be proximate or proximal to the electronic device.

In one or more embodiments, the proximity of an object to an electronic device may be measured as an approximate distance of the object to the electronic device. For example, the proximity sensor(s) may be configured to measure the approximate distance of an object to an electronic device provided that the object is within a range of the proximity sensor(s). The range of the proximity sensor(s) may be the maximum distance that the proximity sensor(s) can measure. Thus, in some instances the term “proximity” and “distance” may be used interchangeably.

In accordance with one or more embodiments, a second proximity sensor may be used to supplement the non-camera proximity sensor. For example, the second proximity sensor may be a camera and may be used to measure proximity of an object only at certain times. By way of further example, the second proximity sensor can be used instead of the non-camera proximity sensor. In yet a further example, the second proximity sensor can be used to enhance the measurements obtained by the non-camera proximity sensor.

Using the second proximity sensor (e.g. a camera) may result in more precise measurements or determinations of the proximity of an object to the electronic device.

In accordance with one or more embodiments, a camera may be calibrated so that it can determine the proximity of an object from a single image of that object.

### Example Electronic Device 102

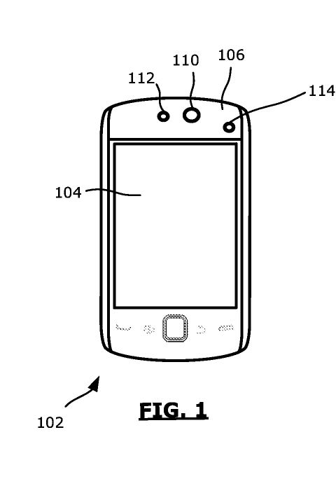

Referring first to FIG. 1, a front view of an example electronic device 102 is illustrated. The electronic device can be a mobile phone, portable computer, smartphone, tablet computer, personal digital assistant, a wearable computer such as a watch, a television, a digital camera or a computer system, for example. By way of further example, the electronic device 102 may be a handheld electronic device 102. The electronic device 102 may be of a form apart from those specifically listed above.

FIG. 1 illustrates a front view of the electronic device 102. The front view of the electronic device 102 illustrates a front face 106 of the electronic device 102. The front face 106 of the electronic device 102 is a side of the electronic device 102 that includes a main display 104 of the electronic device 102. The front face 106 of the electronic device 102 is a side of the electronic device 102 that is configured to be viewed by a user.

The electronic device 102 includes one or more cameras 110. The cameras 110 are configured to generate camera media, such as images in the form of still photographs, motion video or another type of camera data. The camera media may be captured in the form of an electronic signal that is produced by an image sensor associated with the camera 110. Components other than the image sensor may be associated with the camera 110, although such other components may not be shown in the Figures. More particularly, the image sensor (not shown) is configured to produce an electronic signal in dependence on received light. That is, the image sensor converts an optical image into an electronic signal, which may be output from the image sensor by way of one or more electrical connectors associated with the image sensor. The electronic signal represents electronic image data (which may also be referred to as camera media or camera data) from which information referred to as image context may be computed.

In the embodiment illustrated, the electronic device 102 includes a front facing camera 110. A front facing camera is a camera 110 that is located to obtain images of a subject near a front face 106 of the electronic device 102. That is, the front facing camera may be located on or near a front face 106 of the electronic device 102. By way of further example, a front facing camera 110 may face the same direction as the main display 104. In at least some example embodiments, the front facing camera may be provided in a central location relative to the display 104 to facilitate image acquisition of a face. In at least some embodiments, the front facing camera may be used, for example, to allow a user of the electronic device 102 to engage in a video-based chat with a user of another electronic device 102. In at least some embodiments, the front facing camera is mounted internally within a housing of the electronic device 102 beneath a region of the front face 106 which transmits light. For example, the front facing camera may be mounted beneath a clear portion of the housing which allows light to be transmitted to the internally mounted camera.

In other embodiments (not illustrated), the electronic device 102 may include a rear facing camera instead of or in addition to the front facing camera. A rear facing camera is a camera which is located to obtain images of a subject near the rear face of the electronic device 102. That is, the rear facing camera may be generally located at or near a rear face of the electronic device 102. The rear facing camera may be located anywhere on the rear surface of the electronic device 102.

In at least some embodiments (not shown), the electronic device 102 may include a front facing camera and also a rear facing camera. The rear facing camera may obtain images which are not within the field of view of the front facing camera. The fields of view of the front facing and rear facing cameras may generally be in opposing directions.

The electronic device 102 includes a flash 112. The flash 112 may, in at least some embodiments, be a light emitting diode (LED). The flash 112 emits electromagnetic radiation.

More particularly, the flash 112 may be used to produce a brief bright light which may facilitate picture-taking in low light conditions. That is, the flash 112 may emit light while an image is captured using the camera 110. In the embodiment illustrated, the flash 112 is located such that it can emit light from the front face 106 of the electronic device 102. That is, the flash is a front-facing flash in the illustrated embodiment. The electronic device 102 may include a rear-facing flash instead of or in addition to the rear facing flash to emit light at the front face 106 of the electronic device 102. The electronic device 102 may have additional camera hardware which may complement the camera 110.

The electronic device 102 includes a non-camera proximity sensor 114. The non-camera proximity sensor 114 is shown on the front face 106 in the illustrated embodiments. Generally, the non-camera proximity sensor 114 is on the same face (e.g. the front face 106 or rear face or both) as the camera 110. For example, the camera 110 and the non-camera proximity sensor 114 may both be on the rear face. The non-camera proximity sensor 114 is a proximity sensor that is not the camera 110. The non-camera proximity sensor 114 may be behind the transparent cover.

In one or more embodiments, the non-camera proximity sensor 114 includes an infrared (“IR”) proximity sensor. An IR proximity sensor detects distance or proximity by emitting IR light and measuring the amount or intensity of light reflected off an object back to the sensor. The IR proximity sensor may have a different level of precision in determining the proximity of an object depending on how far the object is from the IR proximity sensor. For example, the closer an object is to the IR proximity sensor, the more precise the determination from the IR proximity sensor will be. In one or more embodiments, the IR proximity sensor may operate by determining whether the amount or intensity of reflected IR light is greater than a threshold amount or intensity of reflected IR light. Use of a threshold amount or intensity of light can indicate whether the object that reflected the IR light is within a certain distance to the IR proximity sensor. By way of further example, the IR proximity sensor may measure the amplitude of reflected light (e.g. reflected LED light). In this way the IR proximity sensor may be configured to determine the proximity of an object (off of which the LED light reflects) in relation to the IR proximity sensor.

In one or more embodiments, the non-camera proximity sensor 114 includes a time-of-flight proximity sensor. The time-of-flight proximity sensor can be configured to emit and receive light (such as through an associated infrared spectrum light emitter, such as a LED or laser). The time between the emission of light and the reception of the reflected light can be accurately measured by the time-of-flight proximity sensor 114. An estimation of the distance that an object is from the time-of-flight proximity sensor (or an estimation of the proximity of the object from the time-of-flight proximity sensor) can be obtained using the known speed of light and the measurement of time that it takes light to travel from the time-of-flight proximity sensor (or a related light emitter) to an object and back to the time-of-flight proximity sensor.

The time-of-flight proximity sensor may have a different level of precision in operation than the IR proximity sensor under similar circumstances. For example, the time-of-flight proximity sensor may have a higher degree of precision in operation (as compared to the IR proximity sensor) when it is more than one meter away from the object as compared to when it is less than one meter aware from the object. The degree of precision may refer to the level of certainty that an object is within a certain distance or proximity to the time-of-flight proximity sensor.

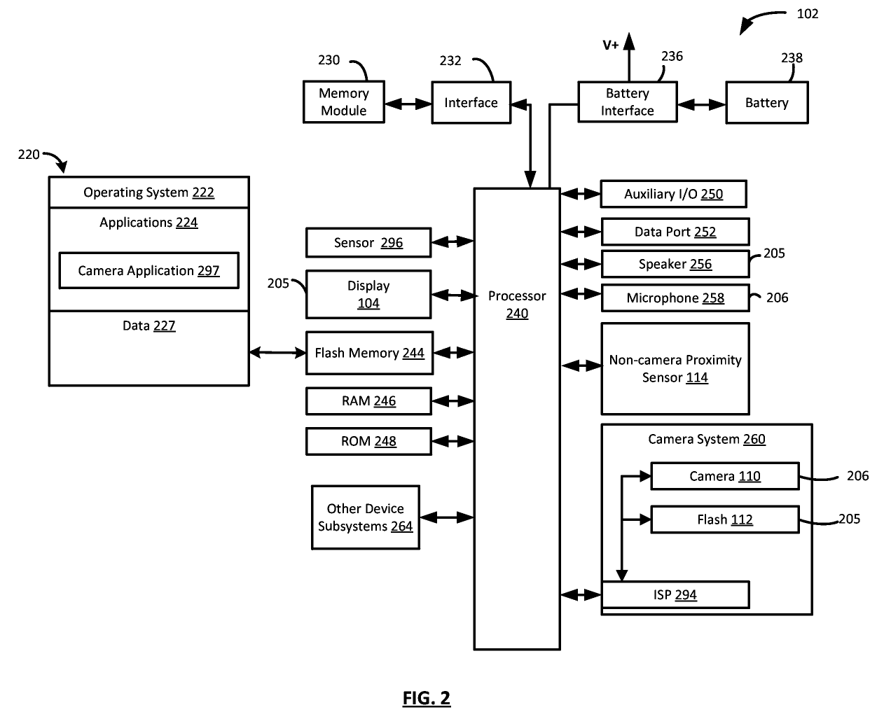

Referring now to FIG. 2, a block diagram of an example electronic device 102 is illustrated. The electronic device 102 of FIG. 2 may include a housing that houses components of the electronic device 102. Internal components of the electronic device 102 may be constructed on a printed circuit board (PCB). The electronic device 102 includes a controller including at least one processor 240 (such as a microprocessor) that controls the overall operation of the electronic device 102. The processor 240 interacts with device subsystems such as a wireless communication subsystem for exchanging radio frequency signals with a wireless network to perform communication functions. The processor 240 interacts with additional device subsystems including one or more input interfaces 206 (such as a keyboard, one or more control buttons, one or more microphones 258, one or more cameras 110, and/or a touch-sensitive overlay associated with a touchscreen display), flash memory 244, random access memory (RAM) 246, read only memory (ROM) 248, auxiliary input/output (I/O) subsystems 250, a data port 252 (which may be a serial data port, such as a Universal Serial Bus (USB) data port), one or more output interfaces 205 (such as the display 104 (which may be a liquid crystal display (LCD)), a flash 112, one or more speakers 256, or other output interfaces), a sensor 296 (such as a gyroscope, accelerometer or other movement sensor), and other device subsystems generally designated as 264. Some of the subsystems shown in FIG. 2 perform communication-related functions, whereas other subsystems may provide “resident” or on-device functions.

The electronic device 102 may include a touchscreen display in some example embodiments. The touchscreen display may be constructed using a touch-sensitive input surface connected to an electronic controller. The touch-sensitive input surface overlays the display 104 and may be referred to as a touch-sensitive overlay. The touch-sensitive overlay and the electronic controller provide a touch-sensitive input interface 206 and the processor 240 interacts with the touch-sensitive overlay via the electronic controller. That is, the touchscreen display acts as both an input interface 206 and an output interface 205.

In some example embodiments, the auxiliary input/output (I/O) subsystems 250 may include an external communication link or interface, for example, an Ethernet connection. The electronic device 102 may include other wireless communication interfaces for communicating with other types of wireless networks; for example, a wireless network such as an orthogonal frequency division multiplexed (OFDM) network.

In some example embodiments, the electronic device 102 also includes a removable memory module 230 (typically including flash memory) and a memory module interface 232. Network access may be associated with a subscriber or user of the electronic device 102 via the memory module 230, which may be a Subscriber Identity Module (SIM) card for use in a GSM network or other type of memory module for use in the relevant wireless network type. The memory module 230 may be inserted in or connected to the memory module interface 232 of the electronic device 102.

The electronic device 102 may store data 227 in an erasable persistent memory, which in one example embodiment is the flash memory 244. In various example embodiments, the data 227 may include service data having information required by the electronic device 102 to establish and maintain communication with the wireless network. The data 227 may also include user application data such as email messages, address book and contact information, calendar and schedule information, notepad documents, images, and other commonly stored user information stored on the electronic device 102 by its user, and other data. The data 227 may also include data captured using the camera 110, data captured using a movement sensor 296 (e.g. an accelerometer or gyroscope) and data captured using a proximity sensor. The data 227 may, in at least some embodiments, include metadata which may store information about the images. In some embodiments the metadata and the images may be stored together. That is, a single file may include both an image and also metadata regarding that image. For example, in at least some embodiments, the image may be formatted and stored as a JPEG image.

The data 227 stored in the persistent memory (e.g. flash memory 244) of the electronic device 102 may be organized, at least partially, into a number of databases or data stores each containing data items of the same data type or associated with the same application. For example, email messages, contact records, and task items may be stored in individual databases within the electronic device 102 memory. The data 227 may also include proximity information, such as a proximity reading from the non-camera proximity sensor or a proximity reading from a second proximity sensor. Data 227 that includes proximity information may also include a time associated with the proximity information. For example, the time associated with specific proximity information (which may be a specific proximity reading) may include the time when the proximity information was captured by a proximity sensor.

The data port 252 may be used for synchronization with a user's host computer system. The data port 252 enables a user to set preferences through an external device or software application and extends the capabilities of the electronic device 102 by providing for information or software downloads to the electronic device 102 other than through a wireless network (not shown). The alternate download path may for example, be used to load an encryption key onto the electronic device 102 through a direct, reliable and trusted connection to thereby provide secure device communication.

The electronic device 102 also includes a battery 238 as a power source, which is typically one or more rechargeable batteries that may be charged, for example, through charging circuitry coupled to a battery interface 236 such as the serial data port 252. The battery 238 provides electrical power to at least some of the electrical circuitry in the electronic device 102, and the battery interface 236 provides a mechanical and electrical connection for the battery 238. The battery interface 236 is coupled to a regulator (not shown) which provides power V+ to the circuitry of the electronic device 102.

The electronic device 102 can also include one or more movement sensor 296 such as rotation sensors (for example, a gyroscope), a translation sensor (for example accelerometers), and position sensors (for example, magnetometers). The one or more movement sensor 296 is configured to measure a movement of the electronic device 102. For example, the one or more movement sensor 296 may be configured to measure the amount of movement of the electronic device 102 or the one or more movement sensor 296 may be configured to determine whether the electronic device 102 has moved (or rotated as the case may be) more than a predetermined amount (or more than a threshold value). The movement sensor 296 may be connected to the processor 240. For example, the processor may be configured to instruct and control the operation of the movement sensor 296. Alternatively, or additionally, the movement sensor 296 may have an associated microprocessor for controlling and instructing the movement sensor 296. The data sensed or received by the movement sensor 296 may be stored in a memory associated with the electronic device 102.

In the embodiment illustrated, the camera 110 is included in a camera system 260 along with a flash 112, and an image signal processor (ISP) 294. The ISP 294 may be embedded in the processor 240 and it may also be considered as a functional part of the camera system 260. In at least some embodiments, the camera 110 may be associated with a dedicated image signal processor 294 which may provide at least some camera-related functions, with the image signal processor 294 being either embedded in the camera 110 or a separate device. For example, in at least some embodiments, the image signal processor 294 may be configured to provide auto-focusing functions. Functions or features which are described below with reference to the camera application 297 may, in at least some embodiments, be provided, in whole or in part, by the image signal processor 294.

The camera system 260 associated with the electronic device 102 also includes a flash 112. As noted above, the flash 112 is used to illuminate a subject while the camera 110 captures an image of the subject. The flash 112 may, for example, be used in low light conditions. In the example embodiment illustrated, the flash 112 is coupled with the main processor 240 of the electronic device 102. The flash 112 may be coupled to the image signal processor 294, which may be used to trigger the flash 112. The image signal processor 294 may, in at least some embodiments, control the flash 112. In at least some such embodiments, applications associated with the main processor 240 may be permitted to trigger the flash 112 by providing an instruction to the image signal processor 294 to instruct the image signal processor 294 to trigger the flash 112. In one or more embodiments, the image signal processor 294 may be coupled to the processor 240.

In one or more embodiments, the camera system 260 may have a separate memory (not shown) on which the image signal processor 294 can store data and retrieve instructions. Such instructions may, for example, have been stored in the memory by the processor 240, which may in some embodiments also be coupled to the separate memory in the camera system 260.

A predetermined set of applications that control basic device operations, including data and possibly voice communication applications may be installed on the electronic device 102 during or after manufacture. Additional applications and/or upgrades to an operating system 222 or software applications 224 may also be loaded onto the electronic device 102 through a network (e.g. a wireless network), the auxiliary I/O subsystem 250, the data port 252, the short range communication module 262, or other suitable device subsystems 264. The downloaded programs or code modules may be permanently installed; for example, written into the program memory (e.g. the flash memory 244), or written into and executed from the RAM 246 for execution by the processor 240 at runtime.

In some example embodiments, the electronic device 102 may provide two principal modes of communication: a data communication mode and a voice communication mode. In the data communication mode, a received data signal such as a text message, an email message, or webpage download can be processed by an application 224 and then and input to the processor 240 for further processing. For example, a downloaded webpage may be further processed by a web browser or an email message may be processed by the email messaging application and output to the display 104. A user of the electronic device 102 may also compose data items, such as email messages; for example, using an input interface 206 in conjunction with the display 104.

In the voice communication mode, the electronic device 102 provides telephony functions and may operate as a typical cellular phone. The overall operation is similar to the data communication mode, except that the received signals would be output to the speaker 256 and signals for transmission would be generated by a transducer such as the microphone 258. The telephony functions are provided by a combination of software/firmware (i.e., a voice communication module) and hardware (i.e., the microphone 258, the speaker 256 and input devices). Alternative voice or audio I/O subsystems, such as a voice message recording subsystem, may also be implemented on the electronic device 102. Although voice or audio signal output may be accomplished primarily through the speaker 256, the display 104 may also be used to provide an indication of the identity of a calling party, duration of a voice call, or other voice call related information.

The electronic device 102 may also be able to operate in video-call mode (also called video-based chat). For example, when operating in video-call mode the electronic device 102 may operate in both voice communication mode and a video mode. During video-call mode, a video camera may be engaged and may operate while the electronic device 102 is in communication mode. When the electronic device 102 is receiving and transmitting audio data, it may also be capturing video images and transmitting the resulting video data along with the audio data. Similarly, video data may be received and displayed along with the received and output audio data.

The processor 240 operates under stored program control and executes software modules 220, such as applications 224, stored in memory such as persistent memory; for example, in the flash memory 244. As illustrated in FIG. 2, the software modules 220 may include operating system software 222 and one or more additional applications 224 or modules such as, for example, a camera application 297. The processor 240 may also operate to process data 227 stored in memory associated with the electronic device 102.

In the example embodiment of FIG. 2, the camera application 297 is illustrated as being implemented as a stand-alone application 224. However, in other example embodiments, the camera application 297 could be provided by another application or module such as, for example, the operating system software 222. Further, while the camera application 297 is illustrated with a single block, the functions or features provided by the camera application 297 could, in at least some embodiments, be divided up and implemented by a plurality of applications and/or modules. In one or more embodiments, the camera application 297 can be implemented by the ISP 294.

The camera application 297 may, for example, be configured to provide a viewfinder on the display 104 by displaying, in real time or near real time, an image defined in the electronic signals received from the camera 110. The camera application 297 may also be configured to capture an image or video by storing an image or video defined by the electronic signals received from the camera 110 and processed by the image signal processor 294. For example, the camera application 297 may be configured to store an image or video to memory of the electronic device 102.

The camera application 297 may also be configured to control options or preferences associated with the camera 110. For example, the camera application 297 may be configured to control a camera lens aperture and/or a shutter speed. The control of such features may, in at least some embodiments, be automatically performed by the image signal processor 294 associated with the camera 110.

In at least some embodiments, the camera application 297 may be configured to focus the camera 110 on a subject or object. For example, the camera application 297 may be configured to request the image signal processor 294 to control an actuator of the camera 110 to move a lens (which is comprised of one or more lens elements) in the camera 110 relative to an image sensor in the camera 110. For example, when capturing images of subjects which are very close to the camera 110 (e.g. subject at macro position), the image signal processor 294 may control the actuator to cause the actuator to move the lens away from the image sensor.

In at least some embodiments, the image signal processor 294 may provide for auto-focusing capabilities. For example, the image signal processor 294 may analyze received electronic signals to determine whether the images captured by the camera are in focus. That is, the image signal processor 294 may determine whether the images defined by electronic signals received from the camera 110 are focused properly on the subject of such images. The image signal processor 294 may, for example, make this determination based on the sharpness of such images. If the image signal processor 294 determines that the images are not in focus, then the camera application 297 may cause the image signal processor 294 to adjust the actuator which controls the lens to focus the image. The camera application 297 may provide auto-focusing capabilities in response to and depending on a measured distance or proximity of an object in the viewfinder.

In at least some embodiments, the camera application 297 may be configured to control a flash associated with the camera 110 and/or to control a zoom associated with the camera 110. In at least some embodiments, the camera application 297 is configured to provide digital zoom features. The camera application 297 may provide digital zoom features by cropping an image down to a centered area with the same aspect ratio as the original. In at least some embodiments, the camera application 297 may interpolate within the cropped image to bring the cropped image back up to the pixel dimensions of the original.

In one or more embodiments, the camera application 297 may determine or estimate the proximity of an object to the electronic device 102 using an image captured by the camera 110. For example, the camera 110 (and the camera application 297, for example) may be calibrated to determine the proximity or distance of one or more particular objects based on one or more features of those objects. During or after the process of calibrating the camera, certain calibration information may be stored in memory associated with the camera 110 or associated with the electronic device 102. The calibration information may be used at a later date to calculate the proximity or distance of an object to the camera 110 (or to the electronic device 102).

The software modules 220 or parts thereof may be temporarily loaded into volatile memory such as RAM 246. The RAM 246 is used for storing runtime data variables and other types of data or information. Although specific functions are described for various types of memory, this is merely one example, and a different assignment of functions to types of memory could also be used.

In one or more embodiments, the processor 240 can (on executing instructions stored in memory) instruct the one or more non-camera proximity sensor 114 to obtain proximity information. In other words, the processor 240 can instruct the one or more non-camera proximity sensor 114 to determine the proximity of an object to the electronic device 102. The processor 240 can also be configured to instruct the camera 110 to obtain proximity information. For example, the processor 240 (or another component, such as the camera application 297) can instruct the camera 110 to capture multiple image frames, which can then be used to determine the proximity of an object (captured in the image frames) to the electronic device 102.

The non-camera proximity sensor 114 may be configured to determine the proximity of an object to the electronic device 102 and periodic intervals. The time between the periodic intervals may be pre-defined or may depend on one or more external factors (such as the time of day, the intensity of the light received at the electronic device 102, or the movement of the device as measured by a movement sensor).

### Exemplary Method of Determining Proximity

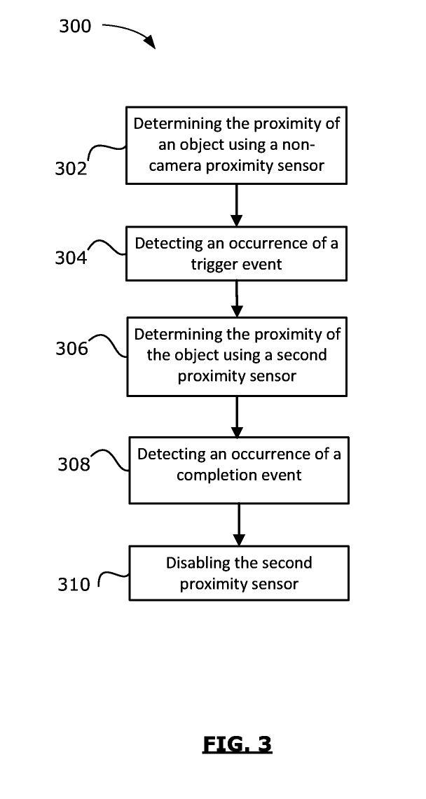

FIG. 3 is a flowchart illustrating an exemplary method 300 of determining a proximity of an object to an electronic device 102. The method 300 may be implemented by a processor, such as the processor 240 described in relation to FIG. 2. For example, the method 300 may comprise computer-executable instructions stored on a computer readable memory, which, when executed, cause a processor to carry out the method 300.

The method 300 can be implemented using the electronic device 102 describe in relation to FIG. 1 or 2.

With reference to the method 300 depicted in FIG. 3, at 302, the proximity of the object to the electronic device 102 is determined using a non-camera proximity sensor 114. The object can be anything with mass and volume, such as a wall, a person, a car, etc. For example, the object can be anything whose proximity can be measured using a non-camera proximity sensor 114.

The proximity of the object to the electronic device 102 may be measured in relation to the front face 106 of the electronic device 102 when the non-camera proximity sensor 114 is configured to determine the proximity of an object relative to the front face 106. For example, the non-camera proximity sensor 114 may only be configured to determine the proximity of an object to the front face 106 of the electronic device 102. By way of further example, the non-camera proximity sensor 114 may only be able to evaluate the proximity of an object to the front face 106 of the electronic device 102 when the object is in front of the front face 106 of the electronic device 102.

The proximity of an object to the electronic device 102 can be the distance (or approximate distance) between the object and the location of the proximity sensor (e.g. a non-camera proximity sensor 114) on the electronic device 102. In other words, the non-camera proximity sensor 114 may be configured to measure the approximate distance between the object and the electronic device 102. Alternatively, the proximity of an object to the electronic device 102 can be a determination of whether the object is within a pre-determined distance to the electronic device 102. In other words, the non-camera proximity sensor 114 may be configured to determine whether an object is proximal (or within the pre-determined distance) to the electronic device 102. The value representing the pre-defined or pre-determined distance may be stored in memory (e.g. flash memory 244), and the determination of whether the object is within a distance that is less than the pre-determined distance may be performed at a processor (such as the processor 240 or another processor associated with the proximity sensor) using data obtained by the proximity sensor (in this case the non-camera proximity sensor 114).

In one or more embodiments, the non-camera proximity sensor 114 may be configured to determine the proximity of objects to the rear face of the electronic device 102. For example, the non-camera proximity sensor 114 may only be able to evaluate the proximity of an object to the rear face of the electronic device 102 when the object is in front of the rear face (or when the object is within a certain position relative to the rear face). In such an embodiment, the proximity will be the distance or proximity (or approximate distance or approximate proximity) of the object from the rear face of the electronic device 102 assuming the object is in front of the rear face of the electronic device 102.

In one or more embodiments, the electronic device 102 may have non-camera proximity sensors 114 on each of its front face 106 and rear face. For example, the electronic device 102 may be configured to determine the proximity of an object from either the front face 106 or the rear face depending on the location of the object. The non-camera proximity sensor 114 on the front face 106 may only be able to determine the proximity of an object (or objects) relative to the front fact 106, and the non-camera proximity sensor 114 on the rear face 106 may only be able to determine the proximity of an object (or objects) relative to the rear face 106. By way of further example, the electronic device 102 may be configured to determine the proximity of the object to the front face 106 if the object is in front of the front face 106 of the electronic device 102, and the electronic device 102 may be configured to determine the proximity of the object to the rear face if the object is in front of the rear face of the electronic device 102.

In one or more embodiments, the non-camera proximity sensor 114 is an infrared proximity sensor. The IR proximity sensor can include an IR light emitter which can emit IR light. In operation, the IR light emitter emits a measured amount or intensity or a certain amount of light. The IR proximity sensor then detects the amount or intensity of light that is reflected back to it. The processor 240 can then use this data (e.g. the amount of emitted light and the amount of received reflected light) to determine an approximate distance to the object that reflected the light or to determine whether the object that reflected the light is within a predefined distance. In other words, the IR proximity sensor can emit light, measure the amount (or intensity or amplitude) of reflected light and from this information determine the proximity (to the IR proximity sensor) of the object which reflected the light. For example, if the IR proximity sensor is configured to detect proximity of an object to the front face 106 of the electronic device 102, then the IR proximity sensor may be configured so that the IR light is emitted outwardly from (e.g. perpendicularly to) the front face 106.

In one or more embodiments, the non-camera proximity sensor 114 is a time-of-flight proximity sensor. The time-of-flight proximity sensor can include a laser light emitter. In operation the laser light emitter emits light, which reflects off of an object, and which is then received at the time-of-flight proximity sensor. The processor 240 (which is coupled to the time-of-flight proximity sensor), or another associated microprocessor, determines the amount of time that lapsed between the emission and reception of the laser light. This amount of time, along with the speed of the emitted light, is then used by the processor to determine the approximate distance of the object off of which the light reflected. In other words, the processor calculates the estimated proximity of the object to the time-of-flight proximity sensor, which in turn may be situated on the front face 106 or the rear face of the electronic device 102. Alternatively, the amount of time, along with the speed of the emitted light, can be used by the processor to determine or approximate whether the object off of which the light reflected is within a predefined distance to the electronic device 102.

The electronic device 102 may have one or more of each of an IR proximity sensor and a time-of-flight proximity sensor (which are both examples of non-camera proximity sensors 114). In an example, the IR proximity sensor and the time-of-flight proximity sensor may operate using the same light emitter. For example, the light may be emitted from a single light emitter and reflected off of an object back to both the IR proximity sensor and time-of-flight proximity sensor. The IR proximity sensor measures the intensity of reflected light and the time-of-flight proximity sensor measures the elapsed travel time of the reflected light.

The non-camera proximity sensor(s) 114 may be associated with its own dedicated processor or microprocessor (as an alternative to or in addition to being associated with the processor 240 of the electronic device 102). For example, the dedicated processor may be configured to calculate a proximity (or estimate a proximity) of an object based on the data determined from the received reflected light (in the case of an IR proximity sensor or time-of-flight proximity sensor).

In one or more embodiments, the non-camera proximity sensor may include an acoustic (SONAR) or microwave (RADAR) measurement method, which may be associated with the electronic device 102. For example, the electronic device 102 (or a component associated with the electronic device 102) can emit ultrasound and measure the elapsed time between the pulse and arrival of the emission. This may also be called the echo return, for example. The methods described herein may also be applicable to other non-camera proximity sensors.

In one or more embodiments, there may be a non-camera proximity sensor 114 on each of the front face 106 and rear face of the electronic device 102. For example, a first non-camera proximity sensor 114 may be configured to determine a proximity (or an estimate of the proximity) of an object to the front face 106 and a second non-camera proximity sensor 114 may be configured to determine a proximity (or an estimate of the proximity) to the rear face of the electronic device 102. The non-camera proximity sensor 114 on the rear face may be a different type of proximity sensor to the one on the front face 106. For example, an IR proximity sensor may be configured to determine the proximity of an object to the front face 106 of the electronic device 102 and a time-of-flight proximity sensor may be configured to obtain the proximity of an object to the rear face of the electronic device 102.

In another embodiment, the front face 106 (or the rear face) may include two non-camera proximity sensors 114, which may be of different types or the same type. One of the two non-camera proximity 114 sensors may be a back-up or redundant proximity sensor and may be used when the other non-camera proximity sensor 114 is not operational or has malfunctioned.

In an embodiment in which a non-camera proximity sensor 114 includes an IR proximity sensor or a time-of-flight proximity sensor (or both), the light that emits from the non-camera proximity sensor 114 (or from a related IR light emitter) may be emitted periodically. For example, the non-camera proximity sensor 114 may be an IR proximity sensor and the IR proximity sensor (or an associated IR light) may emit IR light in bursts at set periodic intervals. In such an embodiment, the IR proximity sensor may be configured to measure or determine the proximity of an object to the IR proximity sensor (e.g. on the electronic device 102) after and using each burst of reflected IR light. Thus, the proximity of an object to the non-camera proximity sensor 114 (which may be on one or both faces of the electronic device 102) may be measured or determined at periodic intervals by the non-camera proximity sensor 114. The periodic intervals may be a certain number of seconds or milliseconds apart, for example.

The non-camera proximity sensor 114 may only be able to determine or calculate the proximity of an object to the electronic device 102 (or to the non-camera proximity sensor 114, which may be associated with the electronic device 102) if the object is within a certain distance from the electronic device 102 (or from the non-camera proximity sensor 114, as the case may be). This maximum distance may be considered the range of the non-camera proximity sensor 114. For example, in an embodiment in which the non-camera proximity sensor 114 is an IR proximity sensor the emitted light may lose its intensity the farther or longer that it travels from the IR light emitter. The reflected light that is received back at the IR proximity sensor may not be intense enough for the IR proximity to obtain or determine a measurement or estimation of proximity.

In one or more embodiments, the processor 240 (or a dedicated processor, as the case may be) may store a threshold proximity value in an associated memory. For example, the threshold proximity value can be a maximum proximity which indicates a value over which the proximity will not be measured. For example, if the non-camera proximity sensor 114 determines (or approximates) that the proximity of an object to the electronic device 102 is more than the threshold proximity value then the non-camera proximity sensor 114 (or an associated processor) indicates that there is no object within range. In other words, the non-camera proximity sensor 114 may return a null value in response to determining (or estimating) that the proximity of the object from which the emitted light was reflected is greater than the threshold proximity value. In one or more embodiments, the determination of the proximity of the object to the electronic device 102 comprises and indication of whether or not the object is within a certain distance to the electronic device 102. In such an embodiment, if it is determined that the object is out of range of the non-camera proximity sensor 114 then the non-camera proximity sensor 114 may indicate that the object is not proximal to the electronic device 102.

The non-camera proximity value may be configured to measure, approximate or determine the proximity of only one object from the electronic device 102. For example, an IR proximity sensor may be configured to measure the proximity only of the first object from which light is reflected. After the IR proximity sensor receives reflected light it may cease measuring for additional reflected light until after further IR light is emitted.

At 304, an occurrence of a trigger event is detected. The occurrence of the trigger event may be detected at the electronic device 102. For example, the processor 240 or one or more proximity sensors (such as a non-camera proximity sensor 114) and associated processors may operate to detect the occurrence of a trigger event. The detection of the occurrence of the trigger event may include a calculation that is carried out by the processor 240 or by a processor associated with one or more proximity sensor.

In one or more embodiments, the detection of the occurrence of the trigger event includes detecting one of a movement of the electronic device 102 and a change in the determined proximity of the object to the electronic device 102. For example, the occurrence of the trigger event may be that the proximity of the object changes. For example, the distance of the object from the electronic device 102 may change so that it moves from proximal to non-proximal.

In an embodiment, the trigger event may be a movement of the electronic device 102 over a threshold amount. For example, the electronic device 102 may include a motion sensor (such as the motion sensor 296 described in relation to FIG. 2), such as an accelerometer or gyroscope that can be used to measure or detect a movement of the electronic device 102. The motion sensor(s) may be associated with the processor 240 or with another dedicated microprocessor. The motion sensor(s) may detect whether an amount of movement of the electronic device 102 is greater than a threshold amount of movement. For example, a memory associated with the electronic device 102 may store the threshold amount of movement, and the processor 240 (or another microprocessor dedicated to the motion sensor(s)) may determine whether the measured amount of movement (as measured by the one or more motion sensor(s)) is greater than the threshold amount of movement. If the measured or detected amount of movement is greater than the threshold amount of movement then the processor 240 (or another microprocessor associated with the motion sensor(s)) will determine that the trigger event has occurred. In other words the occurrence of the trigger event is detected with the measured amount of movement is greater than the threshold amount of movement.

In a further example, the trigger event may be a change in the proximity of the object to the electronic device 102. For example, the non-camera proximity sensor 114 may determine that the proximity of an object to the electronic device 102 as measured (at 302) is not the same as a second determined proximity measurement. By way of further example, the non-camera proximity sensor 114 may periodically measure or periodically determine the proximity (or an estimate of the proximity) to the electronic device 102. When two sequential proximity determinations or measurements are different, then it may be determined that a trigger event has occurred. In one or more embodiments, the proximity determination includes an estimate of the distance of the object from the electronic device 102. In such embodiments the comparison of two sequential proximity measurements may result in the determination that a trigger event has occurred if the two sequential proximity measurements are different by more than a threshold amount (which may be a value stored in a memory associated with the electronic device 102).

There may be more than one trigger event that the electronic device 102 (or a processor 240) evaluates. For example, the processor 240 may be configured to detect the occurrence of one or more trigger event from multiple potential trigger events. Other trigger events may include the initiation of a specific software application (such as a camera application or email application); or the receipt of an incoming message or incoming telephone call (or the receipt of other incoming data); etc. By way of further example, the processor 240 may be configured to detect the first occurrence of a trigger event (out of one or more potential trigger events).

In one or more embodiments, in response to detecting the occurrence of the trigger event, the non-camera proximity sensor 114 may be disabled. For example, after detecting the occurrence of the trigger event, the non-camera proximity sensor 114 may be turned off in response to instructions or operation of the processor 240. The non-camera proximity sensor 114 may only be disabled or turned off for a predetermined amount of time.

At 306, in response to the occurrence of the trigger event, the proximity of the object to the electronic device 102 is determined using a second proximity sensor. For example, after the occurrence of the trigger event is detected, the second proximity sensor may be used to determine the proximity of an object to the same face (e.g. the front face 106 or rear face) of the electronic device 102 on which the non-camera proximity sensor 114 that previously measured proximity of the object to the electronic device 102 is situated. For example, both the non-camera proximity sensor and the second proximity sensor are configured to determine the proximity of an object in respect of the same face of the electronic device 102.

In one or more embodiments, the detection of the occurrence of a trigger event (at 304) is optional in the method 300. For example, the occurrence of the trigger event may be determined other than by a detection at the electronic device 102.

In one or more embodiments, the second proximity sensor is the camera 110. In such an embodiment, the non-camera proximity sensor 114 is on the same face (e.g. the front face 106 or the rear face) of the electronic device 102 as the camera 110. Similarly, detecting the occurrence of the trigger event can include detecting that the camera 110 is in use. For example, the camera 110 may be in use when a camera application (e.g. software that interacts with or assists in the operation of the camera) is launched, initiated or accessed.

While the camera is determining or estimating the proximity of the object to the electronic device 102 the camera 110 captures an image. Thus, on detection of the occurrence of the trigger event, the camera 110 captures (or attempts to capture) an image of the object.

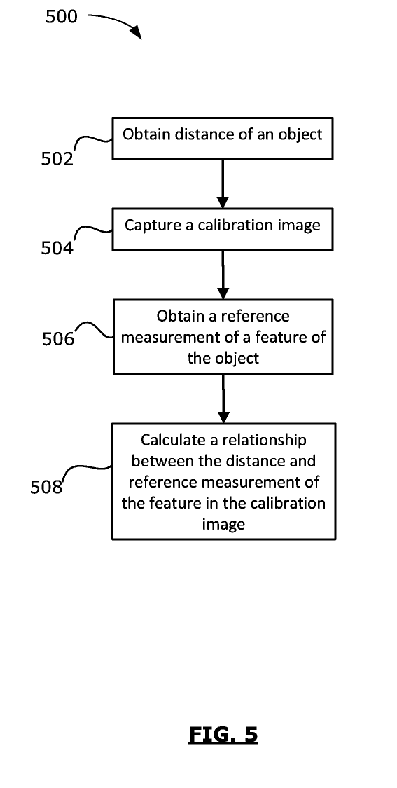

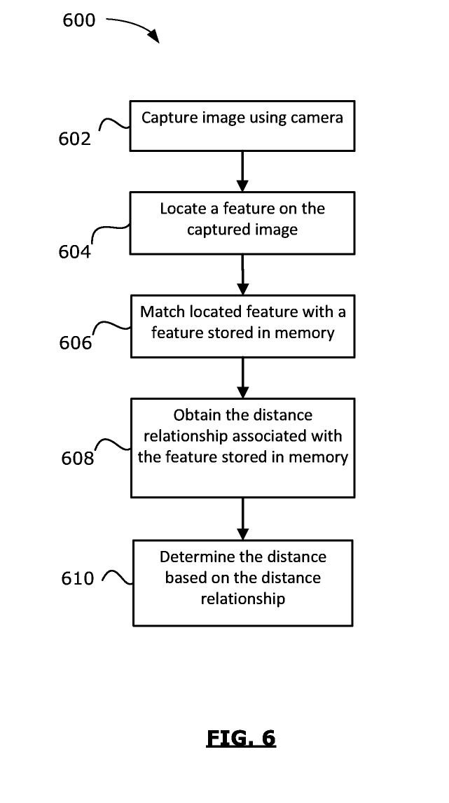

In one or more embodiments, determining or estimating the proximity or distance of the object to the electronic device 102 using the camera 110 is carried out using a camera 110 that has been calibrated in respect of the object. For example, the camera 110 may have been calibrated to detect the proximity of the object from a single captured image of the object based on one or more features associated with the object (where such one or more features is found in the captured image). For example, the camera 110 may be calibrated using a method described below in relation to FIGS. 5 and 6.

In one or more embodiments, determining the proximity of the object to the electronic device 102 can include determining, using the camera 110, that the object is a person. For example, the camera application (or another software application associated with the electronic device 102 or camera 110) may include software recognition, image recognition or image evaluation capabilities. The image captured by the camera 110 in response to the detection of the occurrence of a trigger event can be stored in memory in the electronic device 102. The camera application 297 (or another application) can process the captured image in order to determine whether the object is a person. In an example embodiment, the camera application 297 compares the captured image with one or more images of people stored in memory and determines how similar the captured image is to one more of the stored images. If there is sufficient similarity between the images then the camera application 297 determines that the captured image is that of a person and that, consequently, the object whose proximity from the electronic device 102 is measured is a person. In another embodiment, the determining the proximity of the electronic device 102 can include determining, using the camera 110, that the object is a face or a hand.

In one or more embodiments, the second proximity sensor is used to detect the proximity of the object to the electronic device 102 only after the occurrence of the trigger event is detected. In other words, in one or more embodiments, the second proximity sensor is not used to determine the proximity of the object to the electronic device 102 until after a trigger event is determined to have occurred. For example, in such embodiments the second proximity sensor is not activated (or used to detect proximity) before the occurrence of the trigger event is detected and only the non-camera proximity sensor(s) 114 determines (or approximates) the proximity of the object to the electronic device 102 prior to the detection of the occurrence of the trigger event.

In one or more embodiments, determining the proximity of the object to the electronic device 102 using the second proximity sensor can include determining the proximity of the object to the electronic device 102 using the second proximity sensor for a predetermined amount of time. For example, after the occurrence of the trigger event is detected, the second proximity sensor may be used to determine the proximity of the object to the electronic device 102 over a period of 5 seconds (or over a different time frame). In one or more embodiments, it is only the second proximity sensor that determines the proximity of the object to the electronic device 102 over the predefined amount of time. After the predefined amount of time elapses, the non-camera proximity sensor 114 can again be used to detect the proximity of an object. Alternatively, after the predefined amount of time elapses, the processor can detect whether a trigger event is occurring, and if a trigger event is occurring then the second proximity sensor can be used to determine the proximity of the object to the electronic device 102 for another predetermined amount of time.

In one or more embodiments, the non-camera proximity sensor 114 is an IR proximity sensor and the second proximity sensor is a time-of-flight proximity sensor. Alternatively, in another embodiment, the non-camera proximity sensor 114 is a time-of-flight proximity sensor and the second proximity sensor is an IR proximity sensor.

Optionally, at 308, an occurrence of a completion event is detected. The occurrence of a completion event can be detected by one or more components associated with the electronic device 102. For example, one or more of the proximity sensors (such as the non-camera proximity sensor 114 if not disabled or the second proximity sensor) or a motion sensor 296 (such as an accelerometer or gyroscope) may detect a change which may be considered the occurrence of a completion event. The occurrence of a completion event may be detected at the processor 240. For example, the completion event may be the initiation, opening or closing of an application (such as a camera application 297).

In some embodiments, there may be multiple potential completion events. The detection of the occurrence of a completion event may be the detection of the first occurrence of one of the completion events.

The completion event can include the movement of the electronic device 102 more than a predefined threshold amount. For example, the movement of the electronic device 102 can be detected and measured by a movement sensor 296 (e.g. an accelerometer, gyroscope or magnetometer). This measured movement can be compared to a threshold amount of movement stored in a memory associated with the electronic device 102 in order to determine whether the measured movement is more than the threshold amount of movement. If the measured movement is more than the threshold amount of movement then the processor 240 (or another associated component) may determine that the occurrence of a completion event has occurred. The predefined threshold value can be manually input, downloaded from a remote server or variable dependent on one or more conditions (such as the measured light intensity or the time of day).

The completion event can include a determination that the proximity of the object to the electronic device 102 has not changed more than a threshold amount for at least as long as a predefined amount of time. For example, the processor 240 (or another component) of the electronic device 102 may record or store in memory the time when the measured proximity of an object to the electronic device 102 last changed more than the threshold amount. A memory associated with the electronic device may also store the threshold amount of movement, which may be variable dependent on one or more conditions (such as the measured light intensity or the time of day).

The completion event can include the initiation of the camera application 297. For example, when the camera application 297 is initiated or launched, the processor 240 (or another component) may determine that a completion event is launched. Similarly, the completion event can include the disabling, closing or shutting off of the camera application 297. For example, if the camera application 297 (or an associated application) is closed on the electronic device 102 then it will be determined that a completion event has occurred.

The completion event can include the available power or energy in a battery 238 associated with the electronic device 102. The battery 238 may be used to power the electronic device 102 and the electronic device 102 may include the capability of measuring the remaining power in the battery 238. A memory associated with the electronic device 102 can include a threshold amount of battery power. When the remaining power level of the battery 238 falls below the threshold amount, the processor 240 (or the electronic device 102) may determine that a completion event has occurred. The threshold amount of battery power may be manually set, downloaded, preloaded, or may be variable depending on one or more conditions (such as the measured light intensity or the time of day), for example.

The completion event can include whether the power is turned off on the electronic device 102. For example, the when the power is turned off on the electronic device 102 (e.g. by activating a power-on button on the electronic device 102), the occurrence of a completion event may be determined.

At 310, in response to detecting the occurrence of the completion event, the second proximity sensor is disabled.

In one or more embodiments, after the second proximity sensor is disabled, the non-camera proximity sensor 114 is re-enabled at which point the method 300 may restart.

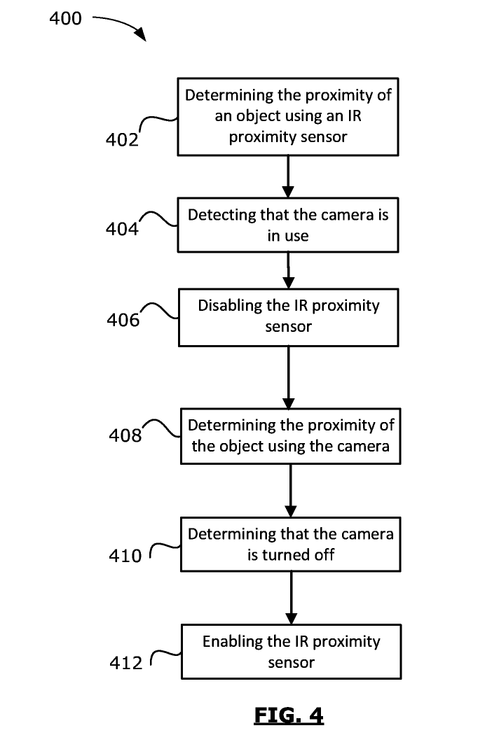

FIG. 4 is a flowchart illustrating another exemplary method 400 of determining a proximity of an object to an electronic device 102. The method 400 may be implemented by a processor, such as the processor 240 described in relation to FIG. 2. For example, the method 400 may comprise computer-executable instructions stored on a computer readable memory, which, when executed, cause a processor to carry out the method 400.

The method 400 can be implemented using the electronic device 102 describe in relation to FIG. 1 or 2.

At 402, the proximity of an object is detected using an IR proximity sensor. For example, the IR proximity sensor may be situated on the front face 106 of the electronic device 102 and may be configured to determine the proximity of an object to the front face 106. The object can be a person, for example. In a further example, the object can be a person's face.

At 404, it is detected that the camera 110 is in use. In one or more embodiments, the detection that the camera 110 is in use can be detecting that the camera application 297 has been launched. For example, the camera application 297 may be launched by receiving specific input at the electronic device 102 (such as the selection of an icon or the selection of a button). The processor 240 (or another component of the electronic device 102) may be configured to determine whether and when the camera application 297 is launched. In one or more embodiments, the camera application 297 may be launched or the camera 110 may be turned on or enabled for the purpose of detecting or measuring distance.

At 406, in response to detecting that the camera 110 is in use, the IR proximity sensor is disabled. In one or more embodiments, in response to the processor 240 detecting that the camera application 297 has been launched, the processor 240 will then instruct the IR proximity sensor to cease emitting IR light or to cease detecting received IR light or both. Alternatively, in response to detecting that the camera application 297 has been launched, the processor 240 will instruct the IR proximity sensor to cease calculating the proximity of an object.

In one or more embodiments, the detection that the camera 110 is in use may comprise detecting that the viewfinder is provided on the display 104 for use by the camera 110 when capturing images.

At 408, the proximity of the object is determined using the camera 110. For example, the camera 110 may have been calibrated to determine the proximity or distance of the object to the camera 110 using a method described below in relation to FIG. 5 or 6.

At 410, it is detected that the camera 110 is turned off. In one or more embodiments, detecting that the camera 110 is turned off can mean detecting that the camera application 297 has been closed or disabled. For example, the electronic device 102 may receive input, such as a touch on a touchscreen, closing the camera application 297. In one or more embodiments, the camera application 297 may automatically turn off or close if it has not been used for a pre-defined period of time.

At 412, the IR proximity sensor is enabled. In one or more embodiments, the IR proximity sensor may be enabled in response to detecting that the camera 110 (or camera application 297) is turned off. For example, the processor may re-enable the IR proximity sensor after instructing the camera application 297 to close itself (in response to input, for example). Re-enabling or enabling the IR proximity sensor can include the processor 240 instructing the IR proximity sensor to emit IR light, capture or sense reflected light, and calculate the proximity of an object based on the captured or sensed light.

FIG. 5 is a flowchart depicting a method 500 of calibrating a camera 110 (and an associated processor, e.g.) to measure the proximity or distance of an object. The method 500 shown in the flowchart of FIG. 5 can be carried out or implemented on a processor associated with the camera 110 or the camera system 260, such as the processer 240, the ISP 294 or by the camera application 297.

In one or more embodiments, the method 500 may be used to calibrate the camera 110 so that the camera 110 will be capable of measuring, estimating or approximating the distance of an object to the camera 110 based on a single image captured by the camera 110. For example, after the camera 110 (or associated processor) is calibrated with respect to a particular object (or with respect to features associated with the object), the camera 110 will be able to determine the distance away from the camera that the object in a captured photographic image is based on the information found in the image. The camera 110 may be integrated with or be part of an electronic device 102 so that the distance between the object and the camera 110 is similar to the distance between the object and the electronic device 102. The calibration technique can be used to calibrate the camera 110 so that the camera 110 can be used as a proximity sensor in one or more of the methods described in relation to FIGS. 3 and 4. For example, using the depicted method 500, the camera 110 can be calibrated to determine or estimate the distance of a specific object based on a single image of that object. When the camera 110 is calibrated, information is obtained with respect to a certain object so that the distance of that object to the camera 110 can then be obtained from a single image without using any other proximity sensors. Accordingly, the camera 110 can be calibrated before proceeding with the methods of determining the proximity of an object to an electronic device described in relation to FIGS. 3 and 4.

A calibration of the camera 110 can be performed using a measurable feature associated with the specific object and a proximity sensor. The feature can be one or more parts or components of an object that can be measured. For example, the object can be a person and a feature can be the distance between that person's eyes. In another example, the object can be a person's hand and the feature can be the distance between known parts of a finger (e.g. the knuckles of finger).

Generally, to calibrate the camera 110 or associated processor the distance to the object is captured using a proximity sensor at the same time that a photographic image of the object is captured. This initially measured distance may be referred to as the “calibration distance”. A processor associated with the camera can then obtain the actual distance to the object (from the proximity sensor) and a measurement of the feature in the image. The measurement of the feature in the image can be the measurement in the actual image (e.g. the number of pixels in length of the feature in the captured image stored in memory). One or more relationships between these variables can be stored in memory. When an image of the object (including the associated feature) is captured at a later time, the processor can then estimate a proximity or distance of the object to the camera using the relationship that is stored in memory and the newly measured distance of the feature in the image. The measurement of the feature in the initial image (i.e. in the calibration image) can be called the “reference measurement of the feature”.

In one or more embodiments, the ratio of the reference measurement of the feature (i.e. the measurement of the feature in the calibration image) to the measurement of the feature in a new image (i.e. in a newly captured image) corresponds to the ratio of the distance of between the object and the camera when the new image is captured to the calibration distance. The following mathematical equation describes an exemplary embodiment of a relationship that can be stored in memory following calibration of the camera 110. This equation may be used to determine the distance between an object and the camera using a single captured image of the object and may be referred to herein as “equation (1)”.

$$d = \frac{{d}_{0} {p}_{0}}{p}$$

In the above exemplary equation, d is the actual distance between the object and the camera 110 at the time of the newly captured image (i.e. when the newly captured image of the object was captured); d₀ is the calibration distance or the distance measured by the proximity sensor between the object and the camera at the time of calibration (i.e. when the calibration image was captured); p₀ is the reference measurement of the feature or the measurement of the feature in the calibration image (i.e. in the image captured at the time of calibration); and p is the measurement of the feature in the newly captured image. Each of p and p₀ may be measured in pixels for example.

At 502, the distance to an object is obtained using a sufficiently accurate non-camera proximity sensor, such as a time-of-flight sensor. For example, the distance to the object can be obtained using a non-camera proximity sensor such as a time-of-flight proximity sensor or an IR proximity sensor. As such, the distance to the object can be the distance between the non-camera proximity sensor and the object. The object is associated with one or more features. For example, the object may be a person's face and the feature may be the distance between the person's eyes.

At 504, a calibration image is captured. The calibration image can be a photographic image and includes the object and the feature(s) associated with that object. For example, the object and the associated feature(s) are captured in the calibration image. In accordance with one or more embodiments, the calibration image is captured at the same time as when the proximity is determined at 502.

At 506, a reference measurement of a feature of the object in the calibration image is obtained. In other words the measurement of the feature as it appears in the captured photographic image is determined. For example, the measurement of the feature can determined a number of pixels in the captured photographic image. By way of further example, if the measurement is of a distance between two components in an image, the measurement can be the number of pixels that connect (i.e. in a straight line) the two components in the captured image. The measurement of the feature can be determined by a processor and stored in memory, for example. The reference measurement can be obtained using one or more different methods. The reference measurement of a feature is a specific measurement of the feature. The feature can be a physical property associated with an object or a distance between components of an object, for example. In one or more embodiments, the feature is the distance between a person's eyes and the object is the person's face. In another embodiment, the feature is the distance between components of a finger (e.g. between knuckles) and the object is a person's hand. In one or more embodiments, the reference measurement is obtained using image analysis.

At 508, a relationship between the distance obtained by the proximity sensor (at 502) and the reference measurement of the feature in the calibration image (determined at 506) is calculated. For example, the memory may store the relationship.

In one or more embodiments, the relationship may be used to calculated equation (1), described above. For example, the memory may store the value d₀p₀ in memory (in other words, the value d₀p₀ may be the relationship). After the camera 110 is calibrated and an image of the object is captured with the camera 110, the relationship may be used to calculate the distance that the object is from the camera 110 in the image using equation (1).

In one or more alternative embodiments, instead of calculating a relationship (at 508), the distance obtained by the proximity sensor (at 502) and the reference measurement of the feature in the calibration image (determined at 506) may be stored in memory. After the camera 110 is calibrated and an image of the object is captured with the camera 110, the stored distance obtained by the proximity sensor and the stored reference measurement may be used to calculate the distance that the object is from the camera 110 in the image using equation (1).

In order to assist with this calculation of equation (1), the measurement of the feature in the captured image is obtained (e.g. by a processor associated with the camera 110). This captured image is the “newly captured image” referenced in respect of equation (1).

FIG. 6 is a flowchart depicting a method 600 of detecting a distance from a camera 110 of an object using the camera which has been calibrated in accordance with the method 500 described in relation to FIG. 5. The method 600 shown in the flowchart of FIG. 6 can be carried out or implemented on a processor associated with the camera 110 or the camera system 260, such as the processer 240, the ISP 294 or by the camera application 297.

At 602, an image is captured using the camera 110. The captured image includes an object with one or more measurable features. The camera 110 has been calibrated in respect of the one or more measurable features. For example, the camera 110 may have been calibrated in accordance with the method described in respect of FIG. 5.

At 604, a feature on the captured image is located. For example, a processor associated with the camera 110 can analyze the captured image to locate one or more features in the captured image. The camera 110 has been calibrated in respect of the features.

At 606, the located feature is matched with a feature stored in memory. In another embodiment, more than one feature is located in the captured image (at 604) and the more than one located features are matched with features stored in memory. For example, the processor 240, ISP 294 or a camera application 297 can match the located feature with a feature stored in memory. The memory can be a flash memory 244 or another memory associated with the electronic device 102.

At 608, the distance relationship associated with stored feature is obtained. The distance relationship is the relationship that was calculated or determined during the calibration of the camera 110 (in respect of that feature). Alternatively, instead of obtained the distance relationship, the processor may obtain the calibration distance and the reference measurement of the feature from memory. The calibration distance may be the distance measured during calibration by the proximity sensor (e.g. at 502) and the reference measurement of the feature may be the reference measurement determined from the calibration image (e.g. at 506).

At 610, the distance of the object in the captured image to the camera 110 is determined based on the obtained distance relationship. For example, the distance of the object may be determined using equation (1). The reference measurement of the feature (p₀) and the calibration distance (d₀) are known from calibration and may be retrieved from a memory associated with the camera 110. The measurement of the feature (p) in the newly captured image (e.g. the image captured at 602) may be calculated by a processor analyzing the captured image (e.g. by counting the number of pixels in length of the feature). The distance (d) of the object in the newly captured image may then be calculated using the equation (1).

In one or more embodiments, a user interface (e.g. content on the display 204) may be automatically adjusted based on a distance measurement provided by the camera 110. For example, the object may be a person's face, and the features may be the distance between the eyes on the person's face. The camera 110 may thus be calibrated to determine or calculate the distance that the person's face is from the electronic device 102 based on a single photographic image. In accordance with an embodiment, the camera 110 may periodically determine the proximity or distance of the person's face (or another object) at pre-determined time intervals. The calculated distance (or proximity) of the object to the electronic device 104 may be used as a basis for one or more automatic operations by the electronic device 102. For example, in response to calculating the distance of an object to the electronic device 102 using the calibrated camera 110, the electronic device 102 may adjust the resolution of the content on the display 104, adjust the size of the content on the display 104, auto-focus the camera 110 and/or viewfinder, enable or disable a gesture input application, etc.

In one or more embodiments, when the distance of the person's face from the electronic device 102 is calculated to be above a pre-determined threshold, the electronic device 102 (e.g. the processor 240) may automatically adjust the content on the display 204 to be larger. For example, if the content on the display 204 is text then the font size of the text may be increased when the person's face is determined to be farther than a predetermined distance from the electronic device 104. Similarly, when the content on the display 204 is an image and the electronic device 103 determines that the person's face is more than a pre-determined distance away, then the electronic device may be configured to increase the size of the image on the display 204 for ease of viewing.

In one or more embodiments, when the electronic device 102 determines that the object is within a predetermined distance to the electronic device 102 using the calibrated camera 110, then the electronic device 102 may enable a previously disabled gesture recognition system or gesture input application. When the gesture recognition or gesture input application is enabled, the electronic device 102 can recognize gestures as input commands.

The term “computer readable medium” or “computer readable storage medium” or “computer readable memory” as used herein means any medium which can store instructions for use by or execution by a computer or other computing device including but not limited to, a portable computer diskette, a hard disk drive (HDD), a random access memory (RAM), a read-only memory (ROM), an erasable programmable-read-only memory (EPROM) or flash memory, an optical disc such as a Compact Disc (CD), Digital Versatile Disc (DVD) or Blu-ray™ Disc, and a solid state storage device (e.g., NAND flash or synchronous dynamic RAM (SDRAM)).

One or more embodiments have been described by way of example. It will be apparent to persons skilled in the art that a number of variations and modifications can be made without departing from the scope of what is defined in the claims.

What is claimed is the following:

1. A method of determining a proximity of an object to an electronic device, the method comprising:
determining the proximity of the object to the electronic device using a non-camera proximity sensor; and
in response to an occurrence of a trigger event, determining the proximity of the object to the electronic device using a second proximity sensor.

2. The method of claim 1, wherein the occurrence of a trigger event comprises one of a movement of the electronic device and a change in the determined proximity of the object to the electronic device.

3. The method of claim 1, wherein the second proximity sensor comprises a camera.

4. The method of claim 3, further comprising, before determining the proximity of the object to the electronic device using the camera: calibrating the camera to determine the proximity of the object.

5. The method of claim 4, wherein calibrating the camera to determine the proximity of the object comprises:
obtaining a distance of the object using a non-camera proximity sensor;
capturing a calibration image;
obtaining a reference measurement of a feature of the object in the calibration image; and
calculating a relationship between the obtained distance and the reference measurement of the feature in the calibration image.

6. The method of claim 5, wherein determining the proximity of the object using the camera comprises determining the proximity based on the calculated relationship between the obtained proximity and the reference measurement of the feature in the calibration image.

7. The method of claim 5, wherein determining the proximity of the object using a non-camera proximity sensor is performed at the same time as capturing the calibration image.

8. The method of claim 3, wherein the occurrence of a trigger event comprises detecting that the camera is in use.

9. The method of claim 1 wherein the non-camera proximity sensor comprises one of an infrared proximity sensor and a time-of-flight proximity sensor.

10. The method of claim 1, further comprising in response to the occurrence of the trigger event, disabling the non-camera proximity sensor.

11. The method of claim 1, wherein the second proximity sensor is used to detect the proximity of the object only after the occurrence of the trigger event.

12. The method of claim 1, wherein determining the proximity of the object to the electronic device using the second proximity sensor comprises determining the proximity of the object to the electronic device using the second proximity sensor for a predetermined amount of time.

13. The method of claim 1, further comprising:
detecting an occurrence of a completion event; and
in response to detecting the occurrence of the completion event, disabling second proximity sensor.

14. An electronic device comprising:
a non-camera proximity sensor for determining the proximity of an object to the electronic device;
a second proximity sensor for determining the proximity of an object to the electronic device;
a memory for storing instructions; and
a processor for executing instructions stored on the memory, the processor coupled to the non-camera proximity sensor and the second proximity sensor, the processor configured to:
determine the proximity of the object to the electronic device using the non-camera proximity sensor; and
in response to an occurrence of a trigger event, determine the proximity of the object to the electronic device using the second proximity sensor.

15. The electronic device of claim 14, further comprising a movement sensor coupled to the processor for detecting the occurrence of the trigger event.

16. The electronic device of claim 14, wherein the second proximity sensor comprises a camera.

17. The electronic device of claim 14, wherein the non-camera proximity sensor comprises one of an infrared proximity sensor and a time-of-flight proximity sensor.

18. The electronic device of claim 14, wherein the processor is further configured to, in response to the occurrence of the trigger event, disable the non-camera proximity sensor.

19. The electronic device of claim 14, wherein the processor determines the proximity of the object to the electronic device using the second proximity sensor only after the occurrence of the trigger event.

20. A method of calibrating a camera to determine a distance of an object from the camera, the object associated with a feature, the method comprising:
obtaining a distance of the object to the camera using a non-camera proximity sensor;
capturing a calibration image, the calibration image comprising the object;
obtaining a reference measurement of the feature associated with the object in the calibration image; and
calculating a relationship between the distance of the object and the reference measurement of the feature.
